(19) United States
(12) Patent Application Publication
(10) Pub. No.: US 2025/0102103 A1
(43) Pub. Date: Mar. 27, 2025

(54) 18-AXIS ORIENTATION MECHANISM

(71) Applicant: Ching-Hsiang TRUI, Taichung City (TW)

(72) Inventor: Ching-Hsiang TRUI, Taichung City (TW)

(21) Appl. No.: 18/897,432

(22) Filed: Sep. 26, 2024

(30) Foreign Application Priority Data
Sep. 26, 2023 (TW) 112136937

(51) Int. Cl. F16M 11/12; F16M 11/18

(52) U.S. Cl. CPC F16M 11/123; F16M 11/18

(57) ABSTRACT

This disclosure mechanism geometrically constituted by eighteen concentric axes is manipulated for spherical coordinate kinematics. The mechanism includes a top frame set, a low frame set, six top arc-link sets, six low arc-link sets, and six transmit sets.

### FIELD

Two novel applications are filed on the same filing date, Sep. 26, 2024. To simply distinguish these twin applications is the number of concentric axes.

File U.S. patent application Ser. No. 18/897,432, “18-AXIS ORIENTATION MECHANISM”

File U.S. patent application Ser. No. 18/897,422, “24-AXIS ORIENTATION MECHANISM”

The difference between the twin applications is only the number of sub-sets. This application No. 18,897,432, a mechanism behaves eighteen concentric axes, includes a top frame set, a low frame set, six top arc-link sets, six low arc-link sets, and six transmit sets. The other application No. 18,897,422, a mechanism behaves twenty-four concentric axes, includes a top frame set, a low frame set, eight top arc-link sets, eight low arc-link sets, and eight transmit sets.

### BACKGROUND

This disclosure mechanism inherited the similar concentric geometry from our three certified patents. The first certified patent (U.S. Pat. No. 8,579,714B2), the second certified patents (U.S. Pat. No. 9,579,786B2, EP2863102, CN104511904A, JP2014-196071) and the third certified patents (U.S. Pat. No. 9,851,045B2, EP3196532, CN107030682A, JP2017-005465).

The significant difference compared with the third certified patents, new subsystems and features are emphasized: transmit sets which include convey belts, pulleys, idlers, and gears. Via these transmit components, these arc-links are synchronously and concentrically rotated along specified geometric orbits by drive modules to provide necessary torque.

### SUMMARY

This disclosure mechanism geometrically constituted by eighteen concentric axes is manipulated for spherical coordinate kinematics. The mechanism includes a top frame set, a low frame set, six top arc-link sets, six low arc-link sets, and six transmit sets.

### BRIEF DESCRIPTION OF THE DRAWINGS

FIG. 1-1-0: geometrical drawings of [U frame Type I]

FIG. 1-1-1: perspective drawings of [U frame Type I]

FIG. 1-2-0: geometrical drawings of [U frame Type II]

FIG. 1-2-1: perspective drawings of [U frame Type II]

FIG. 1-3-0: geometrical drawings of [U frame Type III]

FIG. 1-3-1: perspective drawings of [U frame Type III]

FIG. 2-1-0: geometrical drawings of [V frame Type I]

FIG. 2-1-1: perspective drawings of [V frame Type I]

FIG. 2-2-0: geometrical drawings of [V frame Type II]

FIG. 2-2-1: perspective drawings of [V frame Type II]

FIG. 2-3-0: geometrical drawings of [V frame Type III]

FIG. 2-3-1: perspective drawings of [V frame Type III]

FIG. 3-1-1: drawings for [Outer Config.] and [Claim 1: Case General]

FIG. 3-1-2: drawings for [Outer Config.] and [Claim 1: Case Special]

FIG. 3-2-1: drawings for [Outer Config.] and [Claim 5: Case General]

FIG. 3-2-2: drawings for [Outer Config.] and [Claim 5: Case Special]

FIG. 4-1-1: drawings for [Inner Config.] and [Claim 1: Case General]

FIG. 4-1-2: drawings for [Inner Config.] and [Claim 1: Case Special]

FIG. 4-2-1: drawings for [Inner Config.] and [Claim 5: Case General]

FIG. 4-2-2: drawings for [Inner Config.] and [Claim 5: Case Special]

FIG. 5-1-1: the 1st embodiment's front-view drawings for [Outer Config.]

FIG. 5-1-2: the 1st embodiment's 3-view drawings for [Outer Config.]

FIG. 5-2-1: the 2nd embodiment's front-view drawings for [Outer Config.]

FIG. 5-2-2: the 2nd embodiment's 3-view drawings for [Outer Config.]

FIG. 5-3-1: the 3rd embodiment's front-view drawings for [Outer Config.]

FIG. 5-3-2: the 3rd embodiment's 3-view drawings for [Outer Config.]

FIG. 5-4-1: the 4th embodiment's front-view drawings for [Outer Config.]

FIG. 5-4-2: the 4th embodiment's 3-view drawings for [Outer Config.]

FIG. 6-1-1: the 1st embodiment's front-view drawings for [Inner Config.]

FIG. 6-1-2: the 1st embodiment's 3-view drawings for [Inner Config.]

FIG. 6-2-1: the 2nd embodiment's front-view drawings for [Inner Config.]

FIG. 6-2-2: the 2nd embodiment's 3-view drawings for [Inner Config.]

FIG. 6-3-1: the 3rd embodiment's front-view drawings for [Inner Config.]

FIG. 6-3-2: the 3rd embodiment's 3-view drawings for [Inner Config.]

FIG. 6-4-1: the 4th embodiment's front-view drawings for [Inner Config.]

FIG. 6-4-2: the 4th embodiment's 3-view drawings for [Inner Config.]

This disclosure mechanism is respectively designated into two categories of symbols for [Outer Config.] and [Inner Config.]:

[Outer Config.] of this Disclosure Mechanism
[top frame set]: a [U frame 1f], a [U plate 1d];
[low frame set]: a [V frame 2f], a [V plate 2d];
[top arc-link set]: at least one [U drive gear pair 1g], at least one [U drive module 1m], a [U slave gear pair 1h], a [U axle pair 1a], a [U arc-link 1c];
[low arc-link set]: a [V axle pair 2a], a [V arc-link 2c], a [M axle pair 3a], a [M rotate module 3n];
[transmit set]: at least one [W drive gear pair 3g], at least one [W drive module 3m], a [W slave gear pair 3h], a [W drive pulley 3p], a [W slave pulley 3q], a [W convey belt 3b], at least one pair of [W idlers 3z].
   [Inner Config.] of this Disclosure Mechanism
[top frame set]: a [V frame 2f], a [V plate 2d];
[low frame set]: a [U frame 1f], a [U plate 1d];
[top arc-link set]: at least one [V drive gear set 2g], at least one [V drive module 2m], a [V slave gear set 2h], a [V axle pair 2a], a [V arc-link 2c];
[low arc-link set]: a [U axle pair 1a], a [U arc-link 1c], a [M axle pair 3a], a [M rotate module 3n];
[transmit set]: at least one [W drive gear pair 3g], at least one [W drive module 3m], a [W slave gear pair 3h], a [W drive pulley 3p], a [W slave pulley 3q], a [W convey belt 3b], at least one pair of [W idlers 3z].

### DETAILED DESCRIPTION

This disclosure mechanism geometrically constituted by eighteen concentric axes is manipulated for spherical coordinate kinematics. The mechanism includes a [top frame set], a [low frame set], six [top arc-link sets], six [low arc-link sets], and six [transmit sets]. A critical issue is how to make a concentric mechanism operate smoothly without mutual interference and/or singularity while contemplating practical design and regulating geometric limitation. Therefore, two configurations are classified for this disclosure, [Outer Config.] and [Inner Config.].

[Outer Config.] of this Disclosure Mechanism

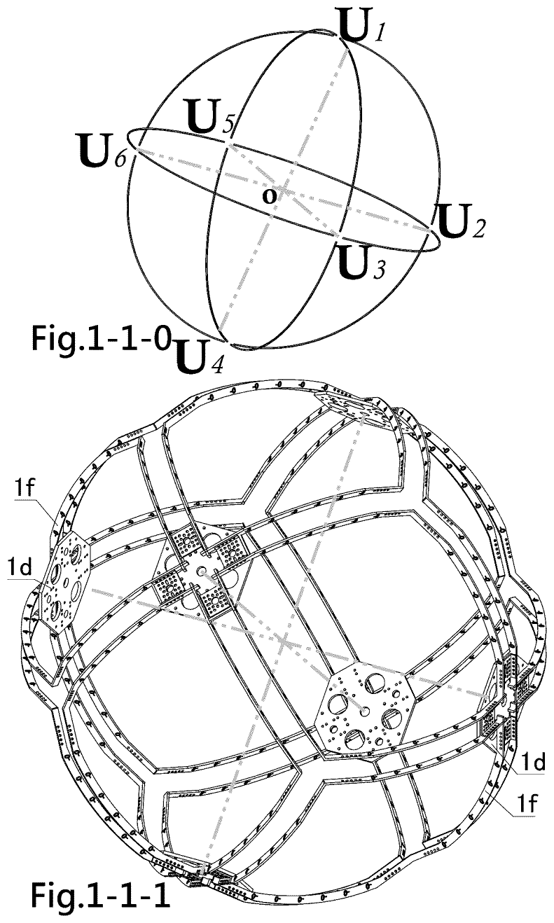

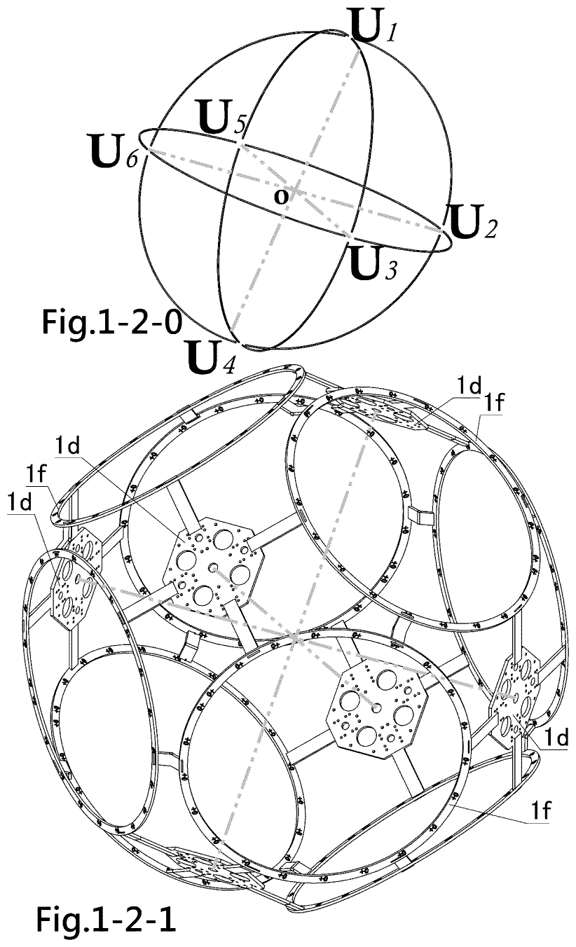

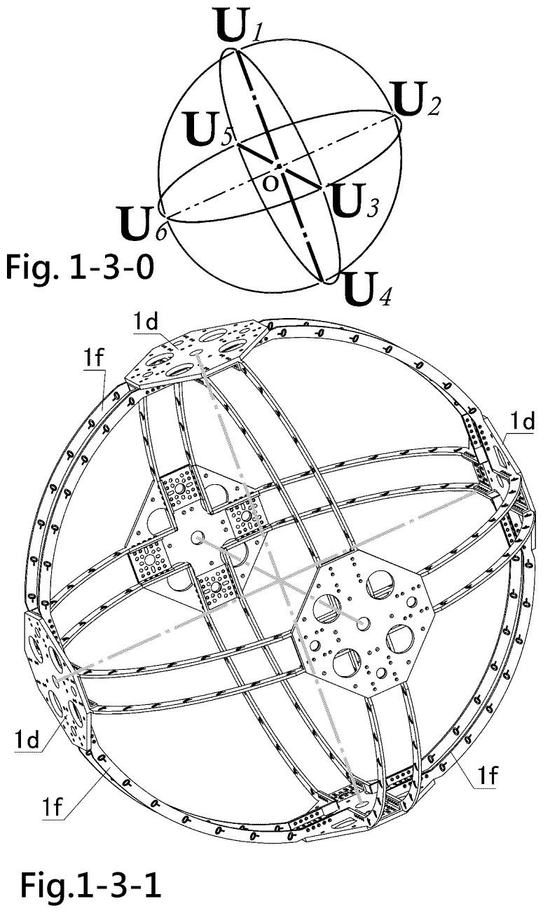

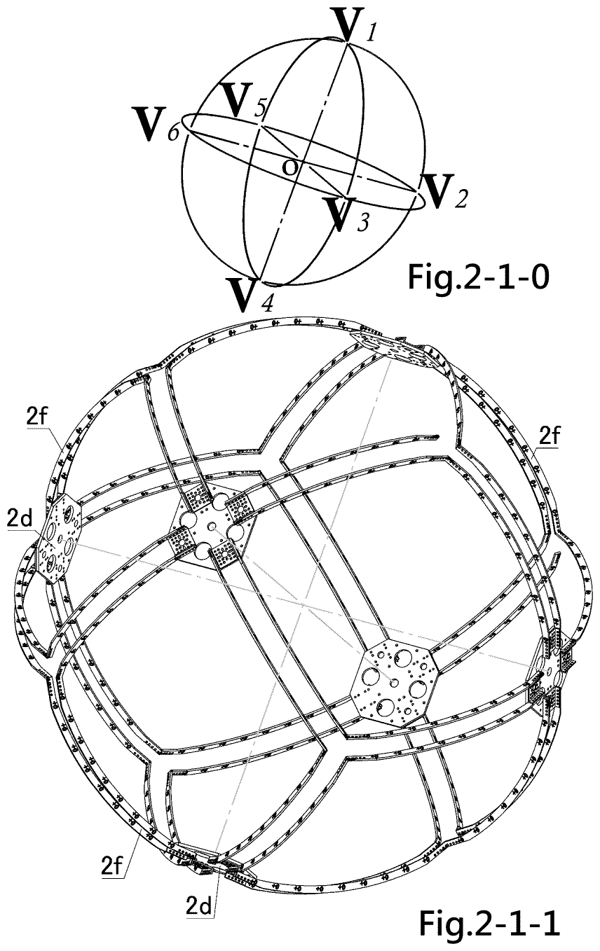

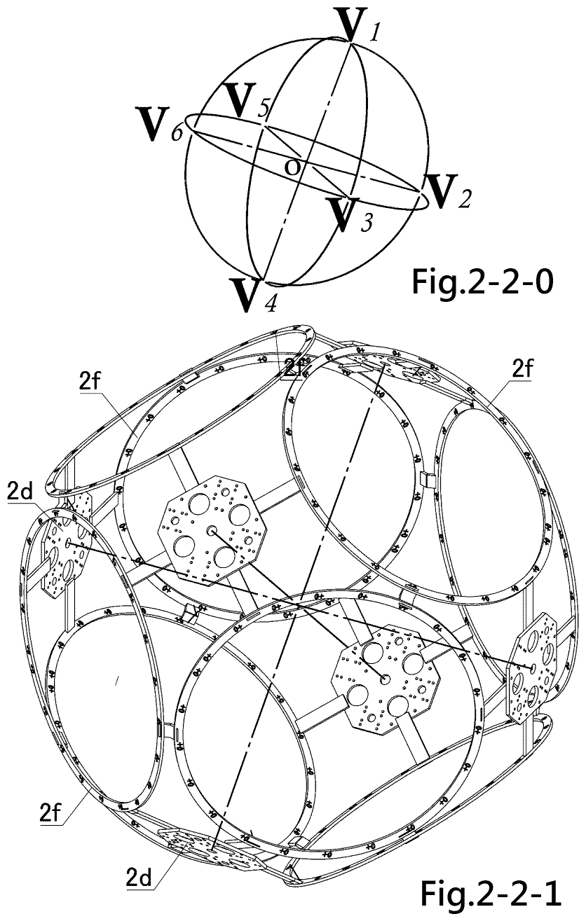

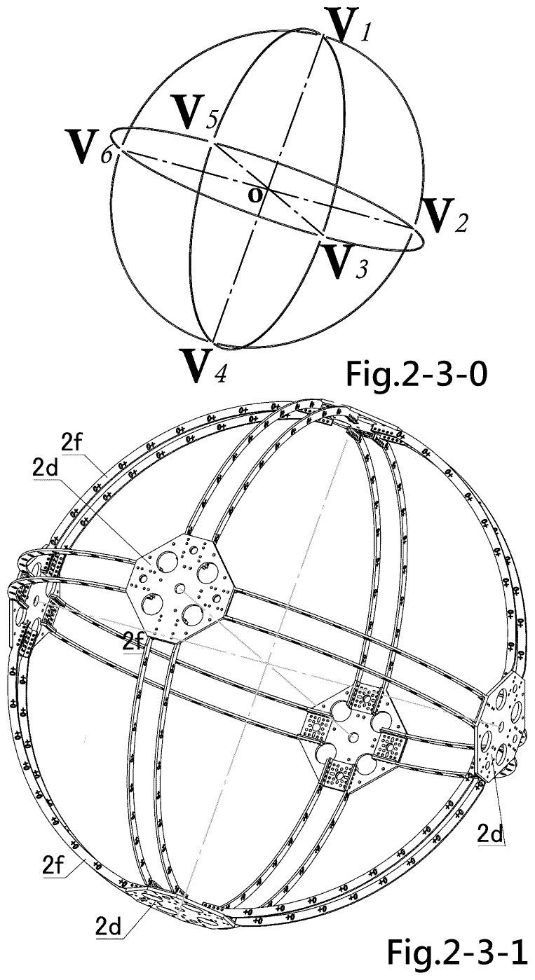

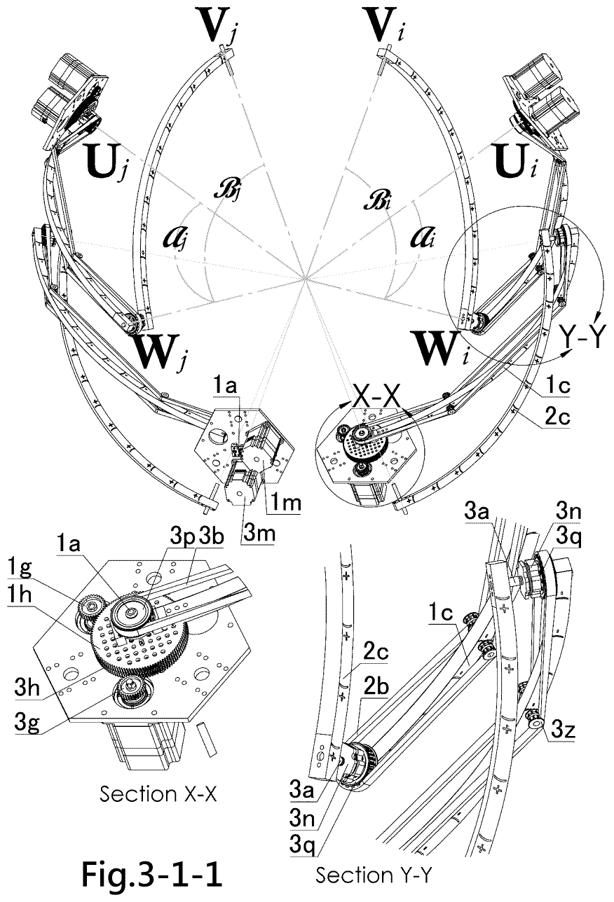

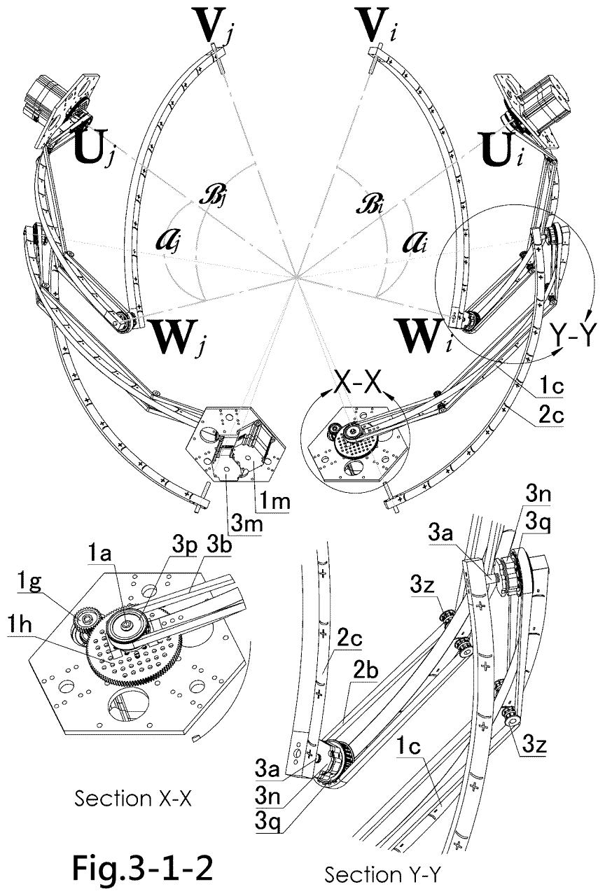

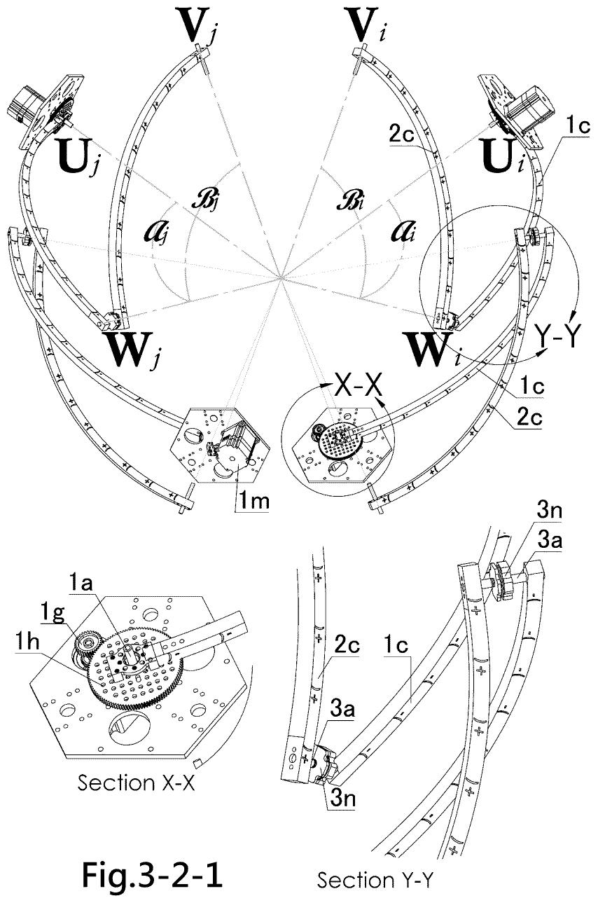

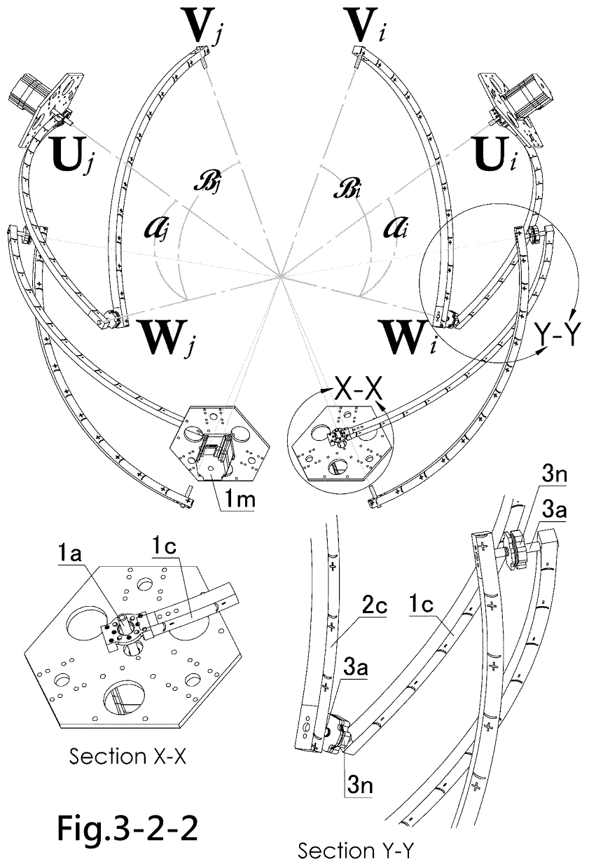

The [top frame set] is “larger” than any geometric orbit of six [top arc-link sets] for preventing interference. The [low frame set] is “smaller” than any geometric orbits of six [low arc-link sets] for preventing interference. Any geometric orbit radius of six [top arc-link sets] is “greater” than any geometric orbit radius of six [low arc-link sets]. Shown as FIG. 3-1-1, FIG. 3-1-2, FIG. 3-2-1, FIG. 3-2-2, FIG. 3-3-1, FIG. 3-3-2, FIG. 3-4-1, FIG. 3-4-2.

[Inner Config.] of this Disclosure Mechanism:

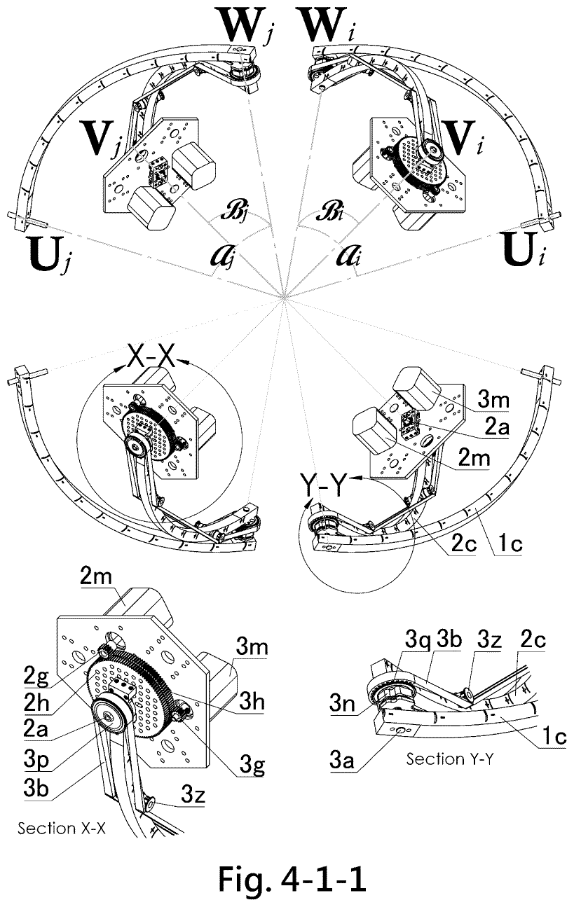

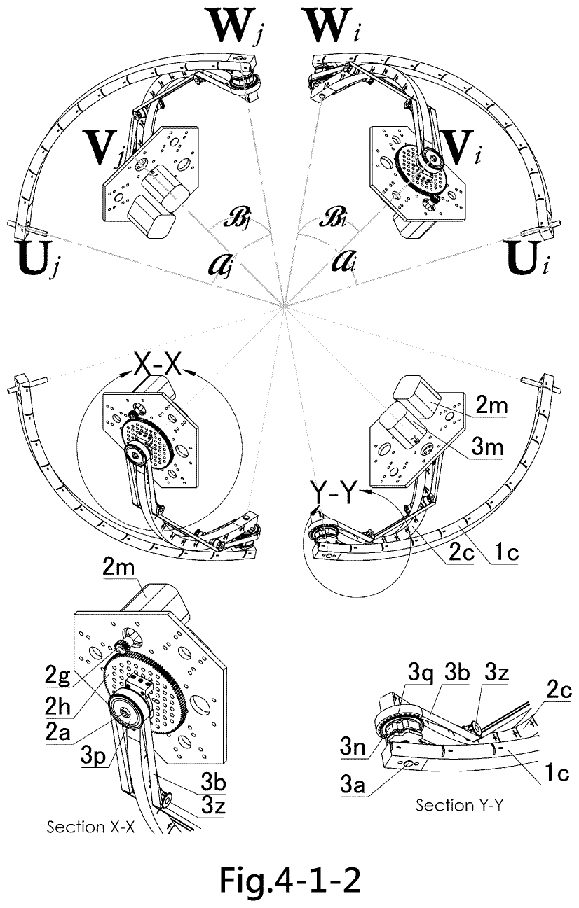

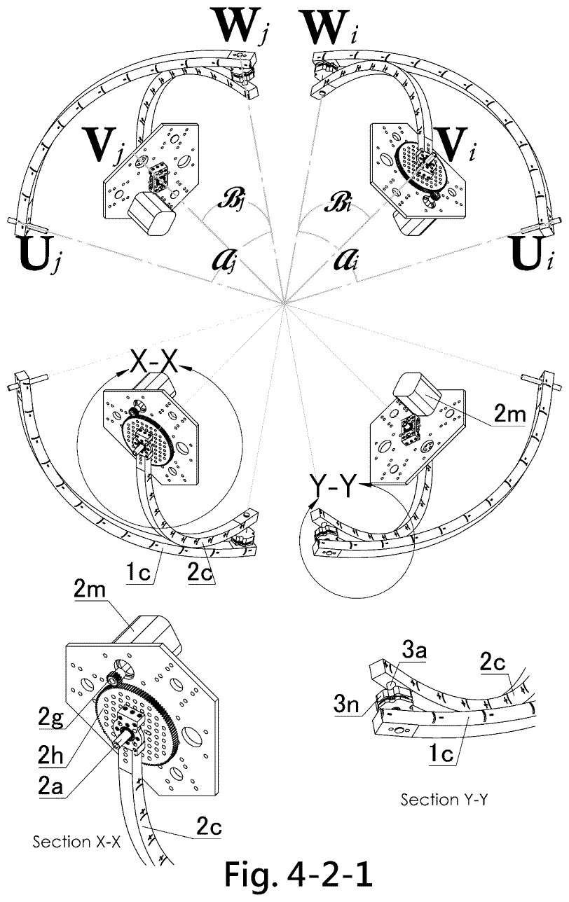

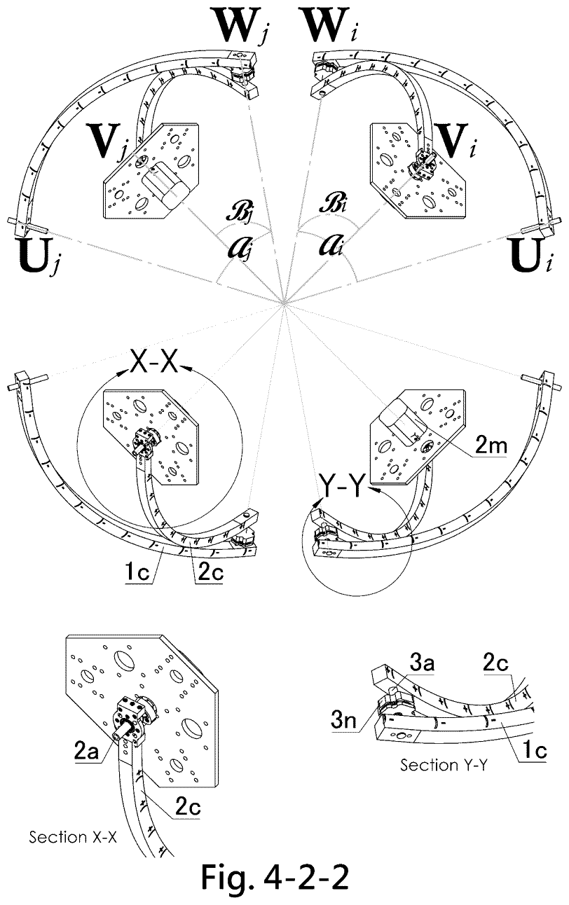

The [top frame set] is “smaller” than any geometric orbits of six [top arc-link sets] for preventing interference. The [low frame set] is “larger” than any geometric orbits of six [low arc-link sets] for preventing interference. Any geometric orbit radius of six [top arc-link sets] is “less” than any geometric orbit radius of six [low arc-link sets]. Shown as FIG. 4-1-1, FIG. 4-1-2, FIG. 4-2-1, FIG. 4-2-2, FIG. 4-3-1, FIG. 4-3-2, FIG. 4-4-1, FIG. 4-4-2.

There are two independent claims, [Claim 1] and [Claim 5] for this disclosure mechanism. The only difference is existence of the six [transmit sets]. Independent [Claim 1] includes six [transmit sets], but independent [Claim 5] excludes six [transmit sets]. Similarly, [Claim 6] and [Claim 7] which are dependent on [Claim 5] are respectively designated and specified to [claims 2] and [claims 3] which are dependent on [Claim 1].

### This Disclosure Mechanism, [18-Axis Orientation Mechanism] Includes:

A [top frame set] comprises a [top frame] and six [top plates]. The [top frame] includes a plurality of brackets and is geometrically defined by six top hexahedron faces. Each top hexahedron face is normal onto a top normal vector which is converged at the center of the [top frame], wherein an angle between any two top normal vectors is greater than 60° and less than 120°. The six [top plates] which are respectively normal onto the six top normal vectors are mounted with the [top frame] to construct the [top frame set].

A [low frame set] comprises a [low frame] and six [low plates]. The [low frame] includes a plurality of brackets and is geometrically defined by six low hexahedron faces. Each low hexahedron face is normal onto a low normal vector which is converged at the center of the [low frame], wherein an angle between any two low normal vectors is greater than 60° and less than 120°. The six [low plates] which are respectively normal onto the six low normal vectors are mounted with the [low frame] to construct the [low frame set].

Six [top arc-link sets], each [top arc-link set] comprises a [top axle pair], at least one [top drive gear pair], at least one [top drive module], a [top slave gear pair] and a [top arc-link].

Each [top axle pair] includes a [top bearing] and a [top axle]. The [top bearing] is mounted onto a corresponded [top plate]. Both ends of the [top axle] are indicated as frame-end and link-end, wherein the [top axle] through the [top bearing] coincides with top normal vector of the [top plate] and points into center of the [top frame set].

Each [top drive gear pair] includes a [top drive bearing] and a [top drive gear]. The [top drive bearing] is mounted onto the corresponded [top plate]. The [top drive module]'s shaft through the [top drive bearing] is pivotally fastened onto the [top drive gear], wherein each [top drive module] can be a motor or a torque output device or an angle sensor or a shaft.

Each [top slave gear pair] includes a [top slave bearing] and a [top slave gear]. According to pre-defined gear ratio, the [top drive gear] and the [top slave gear] are selected to meet design requirement. The [top slave bearing] is mounted onto the [top slave gear]. The [top axle] through the [top gear bearing] is pivotally fastened with the [top slave gear]. The [top slave gear] meshed with the [top drive gear] is synchronously rotated by the [top drive module], wherein distance between both centers of the [top drive gear] and the [top slave gear] is equal to sum of reference radii of the [top drive gear] and the [top slave gear].

Both ends of the [top arc-link] are indicated as frame-end and link-end. The frame-end of [top arc-link] is pivotally fastened onto the [top slave gear].

Consequently, the [top arc-link] is concentrically rotated along specified geometric orbit between the [top frame set] and the [low arc-link]. If the distance between both centers of the [top drive gear] and the [top slave gear] is equal to zero, the [top drive module]'s shaft is directly fastened onto the frame-end of [top axle].

Six [low arc-link sets], each [low arc-link set] comprises a [low axle pair], a [mid axle pair], a [mid rotate module] and a [low arc-link].

Each [low axle pair] includes a [low bearing] and a [low axle]. The [low bearing] is mounted onto a corresponded [low plate]. Both ends of the [low axle] are indicated as frame-end and link-end, wherein the [low axle] through the [low bearing] coincides with low normal vector of the [low plate] and points into center of the [low frame set].

Each [mid axle pair] includes a [mid bearing] and a [mid axle]. Both ends of the [mid axle] are indicated as top-end and low-end.

Both ends of the [low arc-link] are indicated as frame-end and link-end. The [mid bearing] is mounted onto the link-end of [top arc-link]. The [mid axle] is directed through the [mid bearing]. The low-end of [mid axle] pivotally fastens onto the link-end of [low arc-link]. The [mid rotate module]'s shaft is pivotally fastened onto the top-end of [mid axle], wherein each [mid rotate module] can be an angle sensor or a shaft. The frame-end of [low arc-link] is pivotally fastened onto the link-end of the [low axle].

Consequently, the [low arc-link] is concentrically rotated along specified geometric orbit between the [low frame set] and the [top arc-link].

Six [transmit sets], each [transmit set] comprises at least one [trans drive gear pair], at least one [trans drive module], a [trans slave gear pair] and a conveyor set.

Each [trans drive gear pair] includes a [trans drive bearing] and a [trans drive gear]. The [trans drive bearing] is mounted onto the corresponded [top plate]. The shaft of [trans drive module] through the [trans drive bearing] is pivotally fastened onto the [trans drive gear], wherein each [trans drive module] can be a motor or a torque output device or an angle sensor or a shaft.

Each [trans slave gear pair] includes a [trans slave bearing] and a [trans slave gear]. The [trans slave bearing] through the [top axle] is mounted onto the [trans slave gear]. According to pre-defined gear ratio, the [top drive gear] and the [top slave gear] are selected to meet design requirement. The [trans slave gear] is inserted between the [top slave gear] and the corresponded [top plate]. The [trans slave gear] meshed with the [trans drive gear] is synchronously rotated by the [trans drive module], wherein distance between both centers of the [trans drive gear] and the [trans slave gear] is equal to sum of reference radii of the [trans drive gear] and the [trans slave gear].

Each conveyor set includes a [drive pulley], a [slave pulley], a [convey belt] and at least one pair of [idlers].

The [drive pulley] is pivotally fastened onto the link-end of [top axle], wherein each [drive pulley] can be a timing pulley or a winch pulley or a V-groove pulley or a sprocket.

The [slave pulley] is pivotally fastened onto the low-end of [mid axle], wherein each [slave pulley] can be a timing pulley or a winch pulley or a V-groove pulley or a sprocket.

Both sites of the [convey belt] are synchronously meshed and conveyed with the [drive pulley] and the [slave pulley].

Each pair of [idlers] are respectively installed onto both sides and rolled within the outer flange of the [top arc-link], wherein the [convey belt] can be adjusted direction and tension by each pair of [idlers], wherein each [convey belt] can be a timing belt or a round belt or a cable or a chain.

Consequently, the [low arc-link] is synchronously rotated by the [slave pulley] which torque is transmitted via the [convey belt] by the [drive pulley]. If the distance between both centers of the [trans drive gear] and the [trans slave gear] is equal to zero, the [trans drive module]'s shaft is directly fastened onto the frame-end of [top axle].

Designation and Specification of [Outer Config.] of this Disclosure Mechanism:

[Top frame set] which includes a [top frame] and six [top plates] is respectively designated as [U frame set] which includes a [U frame 1f] and six [U plates 1d]. Each normal vector of [U plates 1d] converges at the center of the [U frame 1f], geometrically represented as unit vectors Ui, wherein i=1˜6. Each angle between any two normal vectors of [U plates 1d] is greater than 60° and less than 120°, geometrically represented as 60°<uij<120°, wherein uij=ArcCos (Ui·Uj), i=1˜6, j=1˜6 and i≠j. [U frame set] can be realized by three types. FIG. 1-1-0 and FIG. 1-1-1 for [U frame Type I]. FIG. 1-2-0 and FIG. 1-2-1 for [U frame Type II]. FIG. 1-3-0 and FIG. 1-3-1 for [U frame Type III].

[Low frame set] which includes a [low frame] and six [low plates] is respectively designated as [V frame set] which includes a [V frame 2f] and six [V plates 2d]. Each normal vector of [V plates 2d] converges at the center of the [V frame 2f], geometrically represented as unit vectors Vi, wherein i=1˜6. Each angle between any two normal vectors of [V plates 2d] is greater than 60° and less than 120°, geometrically represented as 60°<vij<120°, wherein vij=ArcCos (Vi·Vj), i=1˜6, j=1˜6 and i≠j. [V frame set] can be realized by three types. FIG. 2-2-0 and FIG. 2-2-1 for [V frame Type I]. FIG. 2-2-0 and FIG. 2-2-1 for [V frame Type II]. FIG. 2-3-0 and FIG. 2-3-1 for [V frame Type III].

[Low arc-link set] which includes a [mid axle pair], a [mid rotate module] a [low axle pair] and a [low arc-link] is respectively designated as [V arc-link set] which includes a [M axle pair 3a], [M rotate module 3n], a [V axle pair 2a] and [V arc-link 2c]. Each vector of [W axle pair 2a] converges at the center of the [U frame 1f], geometrically represented as unit vectors Wi, wherein i=1˜6. Each vector of [V axle pair 2a] concentrically coincides with a normal vector of [V plates 2d] and converges at the center of the [V frame 2f], geometrically represented as unit vectors Vi, wherein i=1˜6. Each arc-length of [V arc-link 2c] is defined as an angle between the vector of [M axle pair 3a] and the vector of [V axle pair 2a] onto a same [V arc-link 1c], geometrically represented as βi=ArcCos (Wi·Vi), wherein i=1˜6.

[Top arc-link set] which includes a [top axle pair], at least one [top drive gear pair], at least one [top drive module], a [top slave gear pair] and a [top arc-link] is respectively designated as [U arc-link set] which includes a [U axle pair 1a], at least one [U drive gear pair 1g], at least one [U drive module 1m], a [U slave gear pair 1h] and a [U arc-link 1c]. Each vector of [U axle pair 1a] concentrically coincides with a normal vector of [U plates 1d] and converges at the center of the [U frame 1f], geometrically represented as unit vectors Ui, wherein i=1˜6. Each arc-length of [U arc-link 1c] is defined as an angle between the vector of [M axle pair 3a] and the vector of [U axle pair 1a] onto a same [U arc-link 1c], geometrically represented as αi=ArcCos (Wi·Ui), wherein i=1˜6.

The [Outer Config.] of this disclosure mechanism is classified into two independent claims, [Claim 1] and [Claim 5].

The independent [Claim 1]“includes” six [transmit sets]: Each pair of [W drive gear] and [W slave gear] is designated as a pair of mid meshed gears. If the distance between both centers of the mid meshed gears is greater than zero, then assigned as [Claim 1: Case General] for [Outer Config.], shown as FIG. 3-1-1. If the distance between both centers of the mid meshed gears is equal to zero, then assigned as [Claim 1: Case Special] for [Outer Config.]; i.e. [W drive gear] and [W slave gear] are neglectable, therefore the shaft of [W drive module 3m] directly fastened onto the frame-end of [U axle pair 1a], shown as FIG. 3-1-2.

The independent [Claim 5]“excludes” six [transmit sets]: Each pair of [U drive gear] and [U slave gear] is designated as a pair of top meshed gears. If the distance between both centers of the top meshed gears is greater than zero, then assigned as [Claim 5: Case General] for [Outer Config.], shown as FIG. 3-2-1. If the distance between both centers of the top meshed gears is equal to zero, then assigned as [Claim 5: Case Special] for [Outer Config.]; i.e. [U drive gear] and [U slave gear] are neglectable, therefore the shaft of [U drive module 1m] directly fastened onto the frame-end of [U axle pair 1a], shown as FIG. 3-2-2.

Designation and Specification of [Inner Config.] of this Disclosure Mechanism:

[top frame set] which includes a [top frame] and six [top plates] is respectively designated as [V frame set] which includes a [V frame 2f] and six [V plates 2d]. Each normal vector of [V plates 2d] converges at the center of the [V frame 2f], geometrically represented as unit vectors Vi, wherein i=1˜6. Each angle between any two normal vectors of [V plates 2d] is greater than 60° and less than 120°, geometrically represented as 60°<vij<120°, wherein vij=ArcCos (Vi·Vj), i=1˜6, j=1˜6 and i≠j. [V frame set] can be realized as three types. FIG. 2-2-0 and FIG. 2-2-1 for [V frame Type I]. FIG. 2-2-0 and FIG. 2-2-1 for [V frame Type II]. FIG. 2-3-0 and FIG. 2-3-1 for [V frame Type III].

[low frame set] which includes a [low frame] and six [low plates] is respectively designated as [U frame set] which includes a [U frame 1f] and six [U plates 1d]. Each normal vector of [U plates 1d] converges at the center of the [U frame 1f], geometrically represented as unit vectors Ui, wherein i=1˜6. Each angle between any two normal vectors of [U plates 1d] is greater than 60° and less than 120°, geometrically represented as 60°<uij<120°, wherein uij=ArcCos (Ui·Uj), i=1˜6, j=1˜6 and i≠j. [U frame set] can be realized as three types. FIG. 1-1-0 and FIG. 1-1-1 for [U frame Type I]. FIG. 1-2-0 and FIG. 1-2-1 for [U frame Type II]. FIG. 1-3-0 and FIG. 1-3-1 for [U frame Type III].

[low arc-link set] which includes a [mid axle pair], a [mid rotate module] a [low axle pair] and a [low arc-link] is respectively designated as [U arc-link set] which includes a [M axle pair 3a], [M rotate module 3n], a [U axle pair 1a] and [U arc-link 1c]. Each vector of [W axle pair 1a] converges at the center of the [U frame 1f], geometrically represented as unit vectors Wi, wherein i=1˜6. Each vector of [U axle pair 1a] concentrically coincides with a normal vector of [U plates 1d] and converges at the center of the [U frame 1f], geometrically represented as unit vectors Vi, wherein i=1˜6. Each arc-length of [U arc-link 1c] is defined as an angle between the vector of [M axle pair 3a] and the vector of [U axle pair 1a] onto a same [U arc-link 1c], geometrically represented as αi=ArcCos (Wi·Ui), wherein i=1˜6.

[top arc-link set] which includes a [top axle pair], at least one [top drive gear pair], at least one [top drive module], a [top slave gear pair] and a [top arc-link] is respectively designated as [V arc-link set] which includes a [V axle pair 2a], at least one [V drive gear set 1g], at least one [V drive module 2m], a [V slave gear set 1h] and a [V arc-link 1c]. Each vector of [V axle pair 2a] concentrically coincides with a normal vector of [V plates 2d] and converges at the center of the [V frame 2f], geometrically represented as unit vectors Vi, wherein i=1˜6. Each arc-length of [V arc-link 2c] is defined as an angle between the vector of [M axle pair 3a] and the vector of [V axle pair 2a] onto a same [V arc-link 2c], geometrically represented as βi=ArcCos (Wi·Vi), wherein i=1˜6.

[transmit set] which includes at least one [trans drive gear pair], at least one [trans drive module], a [trans slave gear pair] and a conveyor set is respectively designated as [W transmit set] which includes at least one [W drive gear pair 3g], at least one [W drive module 3m], a [W slave gear pair 3h] and a [W conveyor set]. [W drive gear pair 3g] includes a [W drive bearing] and a [W drive gear]. [W slave gear pair 3h] includes a [W slave bearing] and a [W slave gear]. [W conveyor set] includes a [W drive pulley 3p], a [W slave pulley 3q], a [W convey belt 3b], at least one pair of [W idlers 3z].

The [Inner Config.] of this disclosure mechanism is classified into two independent claims, [Claim 1] and [Claim 5].

The independent [Claim 1]“includes” six [transmit sets]: Each pair of [W drive gear] and [W slave gear] is designated as a pair of mid meshed gears. If the distance between both centers of the mid meshed gears is greater than zero, then assigned as [Claim 1: Case General] for [Inner Config.], shown as FIG. 4-1-1. If the distance between both centers of the mid meshed gears is equal to zero, then assigned as [Claim 1: Case Special] for [Inner Config.]; i.e. [W drive gear] and [W slave gear] are neglectable, therefore the shaft of [W drive module 3m] directly fastened onto the frame-end of [V axle pair 2a], shown as FIG. 4-1-2.

The independent [Claim 5]“excludes” six [transmit sets]: Each pair of [V drive gear] and [V slave gear] is designated as a pair of top meshed gears. If the distance between both centers of the top meshed gears is greater than zero, then assigned as [Claim 5: Case General] for [Inner Config.], shown as FIG. 4-2-1. If the distance between both centers of the top meshed gears is equal to zero, then assigned as [Claim 5: Case Special] for [Inner Config.]; i.e. [V drive gear] and [V slave gear] are neglectable, therefore the shaft of [V drive module 2m] directly fastened onto the frame-end of [V axle pair 2a], shown as FIG. 4-2-2.

This disclosure mechanism is classified into two configurations, [Outer Config.] and [Inner Config.]. Each configuration is separately realized by four embodiments. Besides, [U frame set] and [V frame set] can be separately realized by three types. Therefore, at least eight embodiments can be introduced.

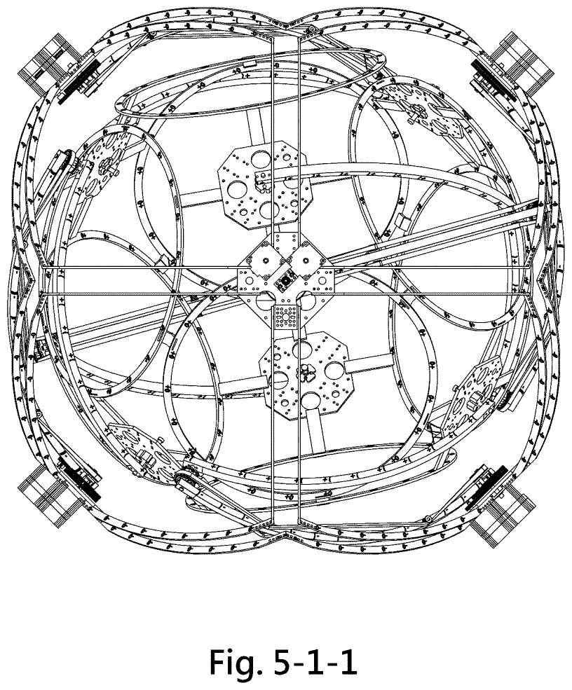

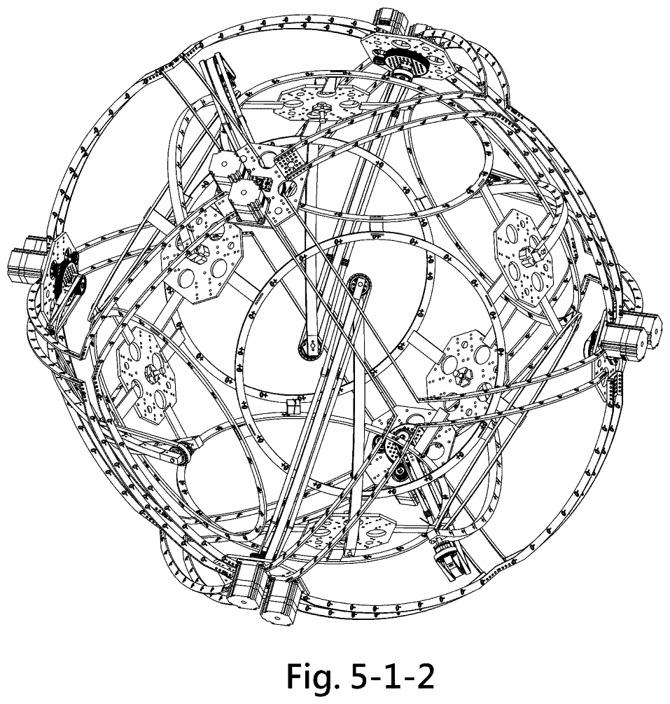

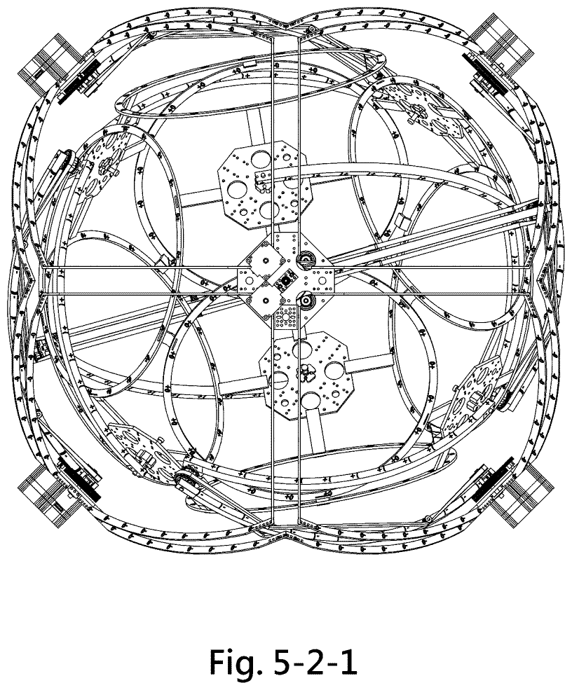

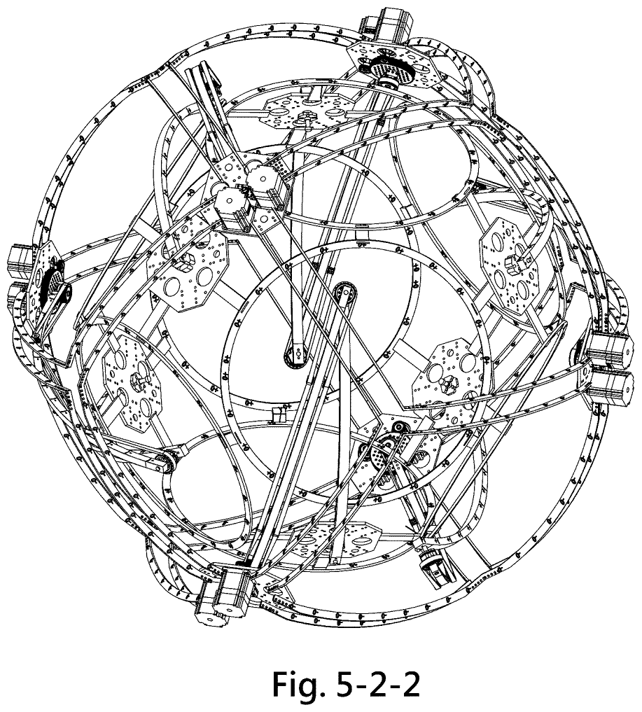

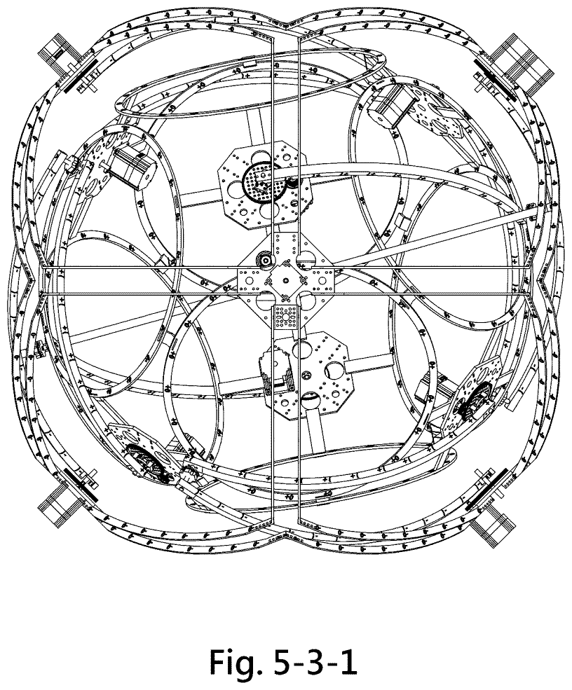

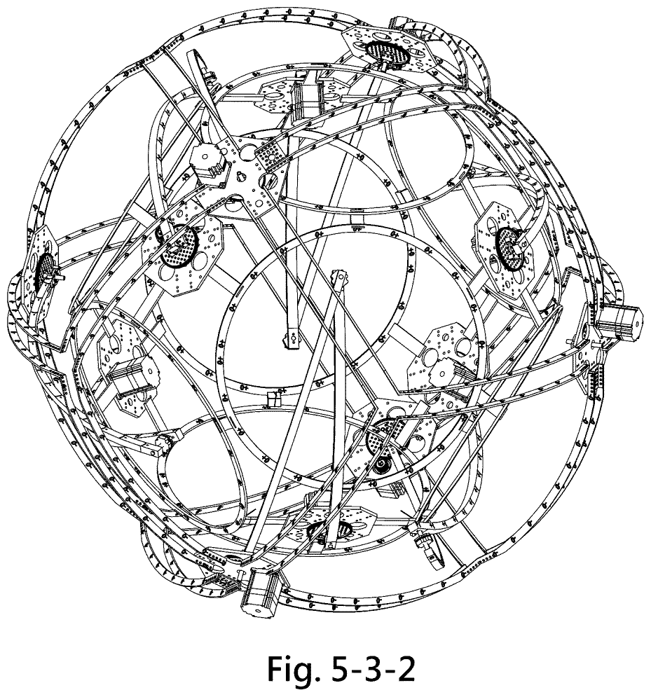

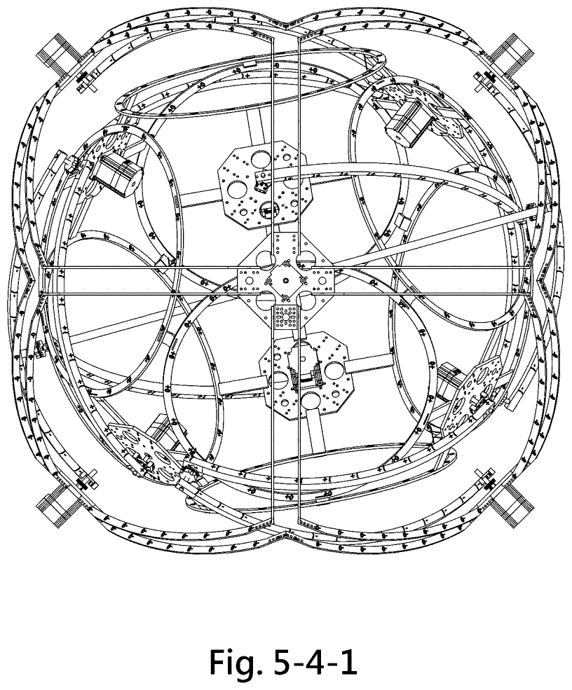

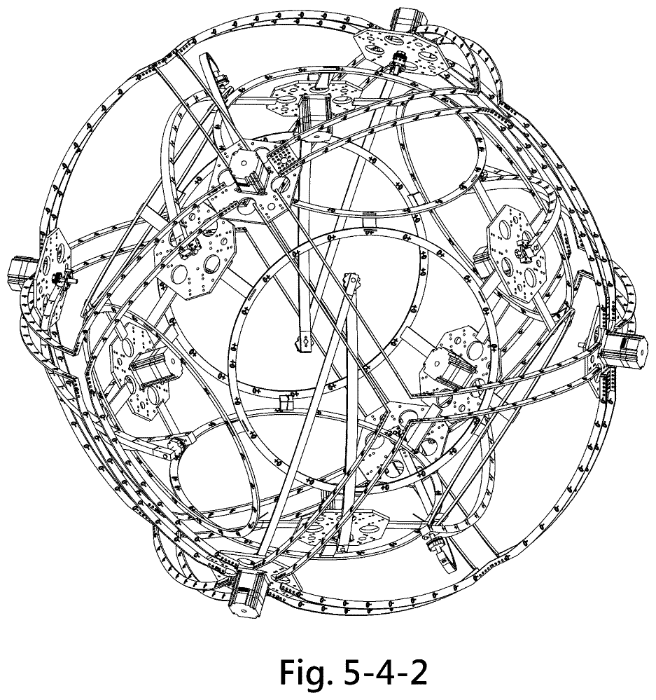

The 1st embodiment of [Outer Config.] is [U frame Type I] and [V frame Type II] for [Claim 1: Case General], shown as FIG. 5-1-1 and FIG. 5-1-2.

The 2nd embodiment of [Outer Config.] is [U frame Type I] and [V frame Type II] for [Claim 1: Case Special], shown as FIG. 5-2-1 and FIG. 5-2-2.

The 3rd embodiment of [Outer Config.] is [U frame Type I] and [V frame Type II] for [Claim 5: Case General], shown as FIG. 5-3-1 and FIG. 5-3-2.

The 4th embodiment of [Outer Config.] is [U frame Type I] and [V frame Type II] for [Claim 5: Case Special], shown as FIG. 5-4-1 and FIG. 5-4-2.

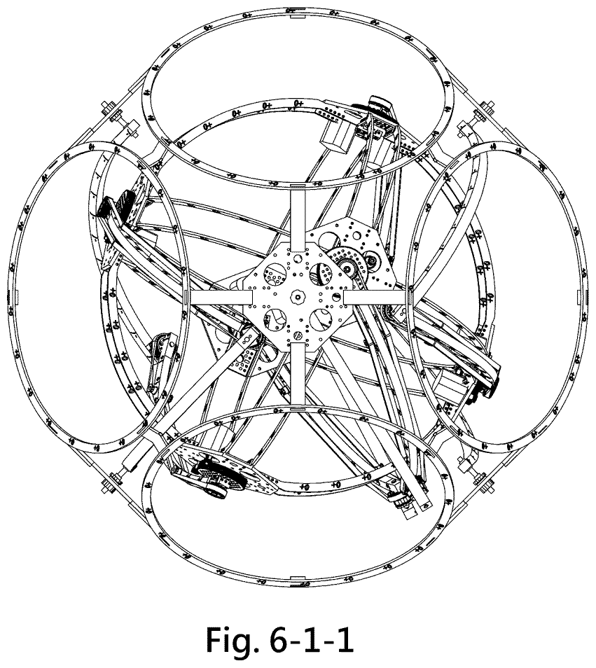

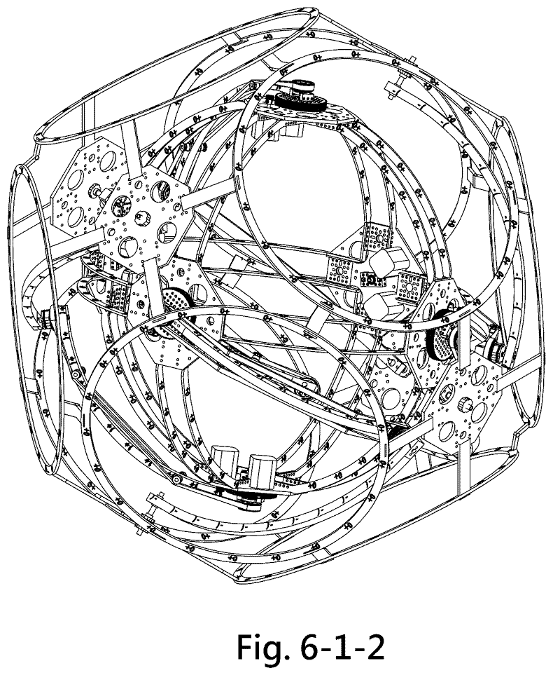

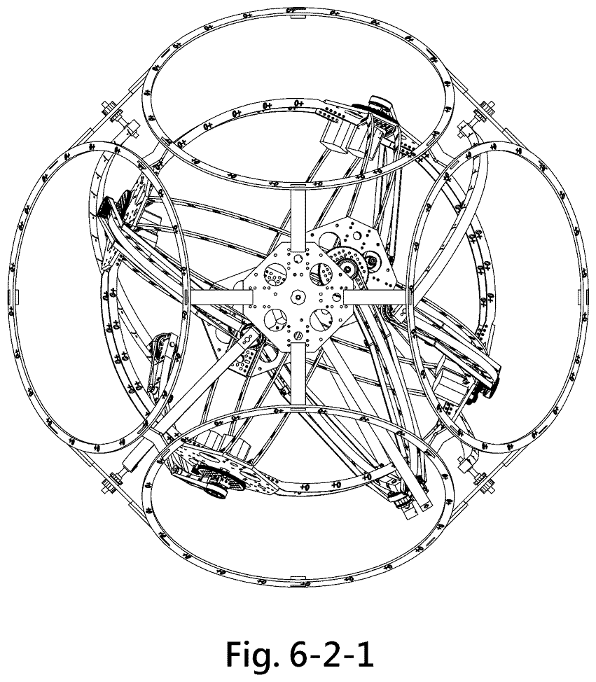

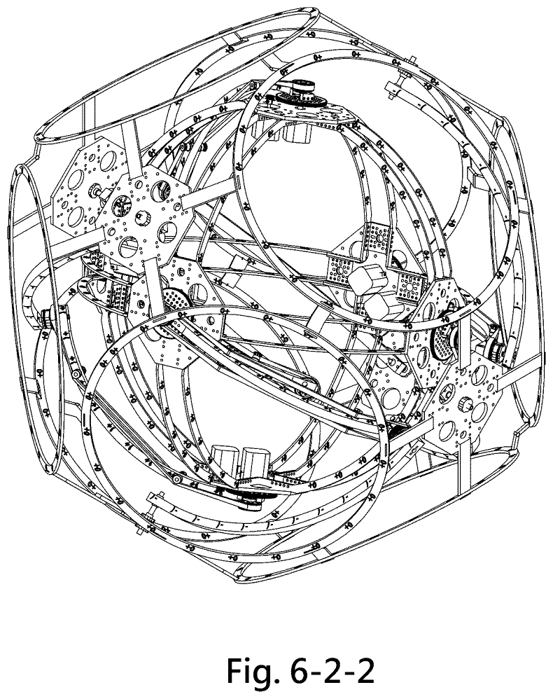

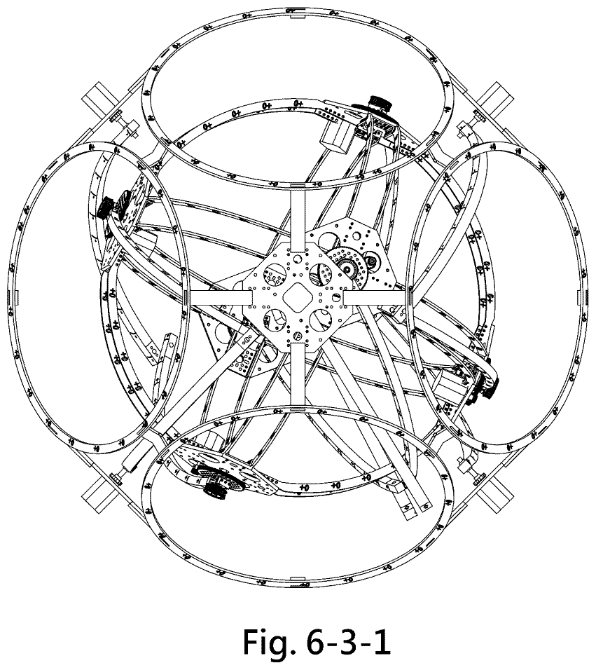

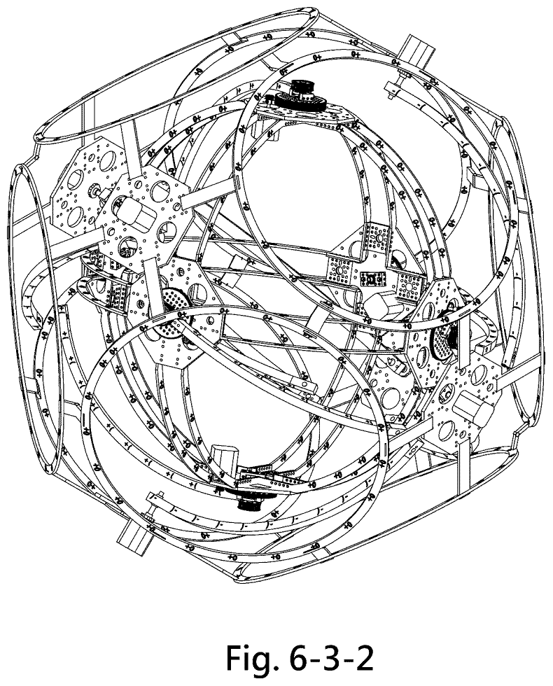

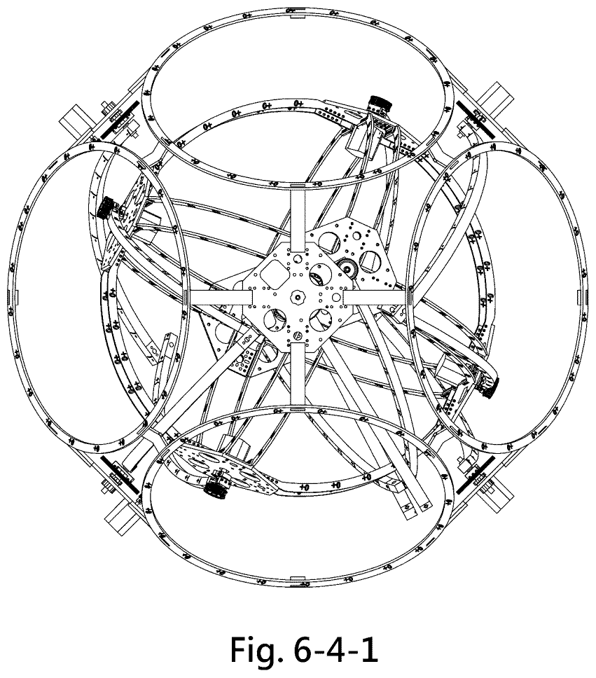

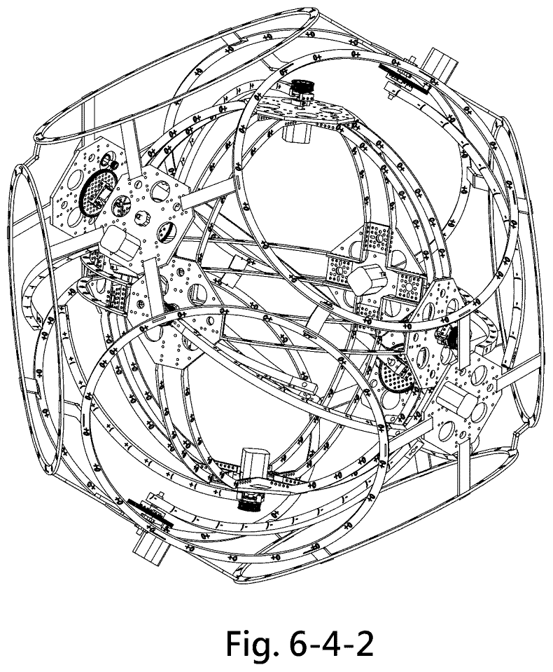

The 1st embodiment of [Inner Config.] is [U frame Type II] and [V frame Type III] for [Claim 1: Case General], shown as FIG. 6-1-1 and FIG. 6-1-2.

The 2nd embodiment of [Inner Config.] is [U frame Type II] and [V frame Type III] for [Claim 1: Case Special], shown as FIG. 6-2-1 and FIG. 6-2-2.

The 3rd embodiment of [Inner Config.] is [U frame Type II] and [V frame Type III] for [Claim 5: Case General], shown as FIG. 6-3-1 and FIG. 6-3-2.

The 4th embodiment of [Inner Config.] is [U frame Type II] and [V frame Type III] for [Claim 5: Case Special], shown as FIG. 6-4-1 and FIG. 6-4-2.

Those skilled in this disclosure will readily observe that numerous modifications and alterations of the device and method may be made while retaining the teachings of The mechanism. Accordingly, the above disclosure should be construed as limited only by the metes and bounds of the appended claims.

1-7. (canceled)

8. A mechanism geometrically constituted by eighteen concentric axes is manipulated for spherical coordinate kinematics, including:
a top frame set comprising a top frame and six top plates, the top frame including a plurality of brackets and being geometrically defined by six top hexahedron faces, each top hexahedron face being normal onto a top normal vector which is converged at the center of the top frame, wherein an angle between any two top normal vectors is greater than 60° and less than 120°, the six top plates which are respectively normal onto the six top normal vectors being mounted with the top frame to construct the top frame set;
a low frame set comprising a low frame and six low plates, the low frame including a plurality of brackets and being geometrically defined by six low hexahedron faces, each low hexahedron face being normal onto a low normal vector which is converged at the center of the low frame, wherein an angle between any two low normal vectors is greater than 60° and less than 120°, the six low plates which are respectively normal onto the six low normal vectors being mounted with the low frame to construct the low frame set;
six top arc-link sets, each top arc-link set comprising a top axle pair, at least one top drive gear pair, at least one top drive module, a top slave gear pair and a top arc-link, each top axle pair including a top bearing and a top axle, the top bearing being mounted onto a corresponded top plate, both ends of the top axle being indicated as frame-end and link-end, wherein the top axle through the top bearing coincides with top normal vector of the top plate and points into center of the top frame set, each top drive gear pair including a top drive bearing and a top drive gear, the top drive bearing being mounted onto the corresponded top plate, the top drive module's shaft through the top drive bearing being pivotally fastened onto the top drive gear, each top slave gear pair including a top slave bearing and a top slave gear, the top slave bearing being mounted onto the top slave gear, the top axle through the top gear bearing being pivotally fastened with the top slave gear, the top slave gear meshed with the top drive gear being synchronously rotated by the top drive module, wherein distance between both centers of the top drive gear and the top slave gear is equal to sum of reference radii of top drive gear and top slave gear, both ends of the top arc-link being indicated as frame-end and link-end, the frame-end of top arc-link being pivotally fastened onto the top slave gear;
six low arc-link sets, each low arc-link set comprising a low axle pair, a mid axle pair, a mid rotate module and a low arc-link, each low axle pair including a low bearing and a low axle, the low bearing being mounted onto a corresponded low plate, both ends of the low axle being indicated as frame-end and link-end, wherein the low axle through the low bearing coincides with low normal vector of the low plate and points into center of the low frame set, each mid axle pair including a mid bearing and a mid axle, the mid bearing being mounted onto the link-end of top arc-link, both ends of the mid axle being indicated as top-end and low-end, the mid axle being directed through the mid bearing, the low-end of mid axle being pivotally fastened onto the link-end of low arc-link, the mid rotate module's shaft being pivotally fastened onto the top-end of mid axle, both ends of the low arc-link are indicated as frame-end and link-end, the frame-end of low arc-link being pivotally fastened onto the link-end of the low axle; and
six transmit sets, each transmit set comprising at least one trans drive gear pair, at least one trans drive module, a trans slave gear pair and a conveyor set, each trans drive gear pair including a trans drive bearing and a trans drive gear, the trans drive bearing being mounted onto the corresponded top plate, the trans drive module's shaft through the trans drive bearing being pivotally fastened onto the trans drive gear, each trans slave gear pair including a trans slave bearing and a trans slave gear, the trans slave bearing through the top axle being mounted onto the trans slave gear, the trans slave gear being inserted between the top slave gear and the corresponded top plate, the trans slave gear meshed with the trans drive gear being synchronously rotated by the trans drive module, wherein distance between both centers of the trans drive gear and the trans slave gear is equal to sum of reference radii of the trans drive gear and the trans slave gear, each conveyor set including a drive pulley, a slave pulley, a convey belt and at least one pair of idlers, the drive pulley being pivotally fastened onto the link-end of top axle, the slave pulley being pivotally fastened onto the low-end of mid axle, both sites of the convey belt being synchronously meshed and conveyed with the drive pulley and the slave pulley, each pair of idlers being respectively installed onto both sides and rolled within the outer flange of the top arc-link.

9. The mechanism according to claim 8, wherein each top drive module can be a motor or a torque output device or an angle sensor or a shaft, wherein each trans drive module can be a motor or a torque output device or an angle sensor or a shaft, wherein each mid rotate module can be an angle sensor or a shaft.

10. The mechanism according to claim 8, wherein the distance between both centers of the top drive gear and the top slave gear is equal to zero, the top drive module's shaft directly fastened onto the frame-end of top axle, wherein the distance between both centers of the trans drive gear and the trans slave gear is equal to zero, the trans drive module's shaft directly fastened onto the frame-end of top axle.

11. The mechanism according to claim 8, wherein each drive pulley can be a timing pulley or a winch pulley or a V-groove pulley or a sprocket, wherein each slave pulley can be a timing pulley or a winch pulley or a V-groove pulley or a sprocket, wherein each convey belt can be a timing belt or a round belt or a cable or a chain.

12. A mechanism geometrically constituted by eighteen concentric axes is manipulated for spherical coordinate kinematics, including:
a top frame set comprising a top frame and six top plates, the top frame including a plurality of brackets and being geometrically defined by six top hexahedron faces, each top hexahedron face being normal onto a top normal vector which is converged at the center of the top frame, wherein an angle between any two top normal vectors is greater than 60° and less than 120°, the six top plates which are respectively normal onto the six top normal vectors being mounted with the top frame to construct the top frame set;
a low frame set comprising a low frame and six low plates, the low frame including a plurality of brackets and being geometrically defined by six low hexahedron faces, each low hexahedron face being normal onto a low normal vector which is converged at the center of the low frame, wherein an angle between any two low normal vectors is greater than 60° and less than 120°, the six low plates which are respectively normal onto the six low normal vectors being mounted with the low frame to construct the low frame set;
six top arc-link sets, each top arc-link set comprising a top axle pair, at least one top drive gear pair, at least one top drive module, a top slave gear pair and a top arc-link, each top axle pair including a top bearing and a top axle, the top bearing being mounted onto a corresponded top plate, both ends of the top axle being indicated as frame-end and link-end, wherein the top axle through the top bearing coincides with top normal vector of the top plate and points into center of the top frame set, each top drive gear pair including a top drive bearing and a top drive gear, the top drive bearing being mounted onto the corresponded top plate, the top drive module's shaft through the top drive bearing being pivotally fastened onto the top drive gear, each top slave gear pair including a top slave bearing and a top slave gear, the top slave bearing being mounted onto the top slave gear, the top axle through the top gear bearing being pivotally fastened with the top slave gear, the top slave gear meshed with the top drive gear being synchronously rotated by the top drive module, wherein distance between both centers of the top drive gear and the top slave gear is equal to sum of reference radii of top drive gear and top slave gear, both ends of the top arc-link being indicated as frame-end and link-end, the frame-end of top arc-link being pivotally fastened onto the top slave gear; and
six low arc-link sets, each low arc-link set comprising a low axle pair, a mid axle pair, a mid rotate module and a low arc-link, each low axle pair including a low bearing and a low axle, the low bearing being mounted onto a corresponded low plate, both ends of the low axle being indicated as frame-end and link-end, wherein the low axle through the low bearing coincides with low normal vector of the low plate and points into center of the low frame set, each mid axle pair including a mid bearing and a mid axle, the mid bearing being mounted onto the link-end of top arc-link, both ends of the mid axle being indicated as top-end and low-end, the mid axle being directed through the mid bearing, the low-end of mid axle being pivotally fastened onto the link-end of low arc-link, the mid rotate module's shaft being pivotally fastened onto the top-end of mid axle, both ends of the low arc-link are indicated as frame-end and link-end, the frame-end of low arc-link being pivotally fastened onto the link-end of the low axle.

13. The mechanism according to claim 12, wherein each top drive module can be a motor or a torque output device or an angle sensor or a shaft, wherein each trans drive module can be a motor or a torque output device or an angle sensor or a shaft, wherein each mid rotate module can be an angle sensor or a shaft.

14. The mechanism according to claim 12, wherein the distance between both centers of the top drive gear and the top slave gear is equal to zero, the top drive module's shaft directly fastened onto the frame-end of top axle, wherein the distance between both centers of the trans drive gear and the trans slave gear is equal to zero, the trans drive module's shaft directly fastened onto the frame-end of top axle.
